(19) United States
(12) Patent Application Publication
(10) Pub. No.: US 2026/0150153 A1
(43) Pub. Date: May 28, 2026

(54) OPERATING A RADIO ACCESS NETWORK OF A MOBILE COMMUNICATION NETWORK WITH AT LEAST ONE USER EQUIPMENT

(71) Applicant: Deutsche Telekom AG, Bonn (DE)

(72) Inventor: Axel Klatt, Cologne (DE)

(21) Appl. No.: 19/481,890

(22) PCT Filed: May 6, 2024
(86) PCT No.: PCT/EP2024/062489

§ 371 Date: Nov. 6, 2025

(30) Foreign Application Priority Data
May 17, 2023 (EP) 23174129.9

(51) Int. Cl. H04W 76/28; H04L 5/00

(52) U.S. Cl. CPC H04W 76/28; H04L 5/0044

(57) ABSTRACT

A method for operating a radio access network of a mobile communication network with at least one user equipment includes: in a first step, the user equipment transmits a scheduling request indication to a base station entity, and in a second step, the base station entity transmits a control signaling to the user equipment, the transmission of the control signaling resulting in the base station entity and the user equipment being configured to apply or to use a further connected mode discontinuous transmission-reception pattern. According to the further connected mode discontinuous transmission-reception pattern, besides repeatedly occurring active time intervals, repeatedly occurring additional active time intervals are defined and used for data transmission and/or reception, in uplink and/or in downlink direction, between the base station entity on the one hand and the user equipment on the other hand.

### CROSS-REFERENCE TO PRIOR APPLICATIONS

This application is a U.S. National Phase application under 35 U.S.C. § 371 of International Application No. PCT/EP 2024/062489, filed on May 6, 2024, and claims benefit to European Patent Application No. EP 23174129.9, filed on May 17, 2023. The International Application was published in English on Nov. 21, 2024 as WO 2024/235721 A1 under PCT Article 21(2).

### FIELD

The present invention relates a method for operating a radio access network of a mobile communication network with at least one user equipment, the radio access network comprising at least one base station entity and the at least one user equipment being connected with, or served by, the at least one base station entity,
wherein, in case that the user equipment is in connected mode, both the base station entity and the user equipment are configured to apply or to use a connected mode discontinuous transmission-reception pattern.

Furthermore, the present invention relates to a user equipment for being operated with a radio access network of a mobile communication network, wherein the user equipment is configured to connect to or be served by at least one base station entity as part of the radio access network,
wherein, in case that the user equipment is in connected mode, the user equipment is configured to apply or to use a connected mode discontinuous transmission-reception pattern.

Furthermore, the present invention relates to a base station entity for being operated as part of a radio access network of a mobile communication network and with at least one user equipment, the user equipment being connected with, or served by, the base station entity,
wherein, in case that the user equipment is in connected mode, both the base station entity and the user equipment are configured to apply or to use a connected mode discontinuous transmission-reception pattern.

Furthermore, the present invention relates to a system or to a telecommunications network for operating a radio access network of the mobile communication network with at least one user equipment, the radio access network comprising at least one base station entity and the at least one user equipment being connected with, or served by, the at least one base station entity,
wherein, in case that the user equipment is in connected mode, both the base station entity and the user equipment are configured to apply or to use a connected mode discontinuous transmission-reception pattern.

Furthermore, the present invention relates to a program and to a computer-readable medium for operating a radio access network of a mobile communication network with at least one user equipment according to an inventive method.

The present invention relates to the area of telecommunications networks, especially wireless telecommunications networks or mobile communication networks.

### BACKGROUND

In conventional telecommunications networks or mobile communication networks, the network nodes or components of the radio access network that are used to provide communication services to a plurality of user equipments typically require a considerable amount of energy in order to be able to provide the required communication services to the user equipments located in the geographical coverage area of the considered mobile communication network.

In order to reduce such power consumption needs, a discontinuous transmission-reception pattern may be used, i.e. within a repeating time interval or cycle of time intervals, during some parts of such time intervals, the respective parts or network nodes or components of the radio access network are—at least partly—powered off (or, at least, powered-down) such as to be able to save energy, and during some other parts of such time intervals, the respective parts or network nodes or components of the radio access network are powered on in order to be able to provide the required communication services to the respective user equipments.

Within a radio cell being served by a base station entity, the base station entity enters a discontinuous transmission-reception pattern such as to be able to reduce its needs in energy consumption, while still being able to provide the required communication services requested from the user equipments; of course, this is typically only possible in situations of off-peak demand of communication services (within the considered radio cell). However, in case that—within the considered radio cell—one user equipment or a plurality of user equipments is/are located that are served by that considered base station entity, some kind of coordination is required between the base station entity on the one hand and the respective user equipments on the other hand in order to be able to apply a discontinuous transmission-reception pattern within the considered radio cell and involving such user equipments.

In case of different communication needs of a plurality of user equipments within a radio cell (or served by a base station entity), it might well be the case that a first kind of discontinuous transmission-reception pattern might be most adapted (or sufficient) regarding a first user equipment (or a first group of user equipments) while a second discontinuous transmission-reception pattern might be most adapted (or required) regarding a second user equipment (or a second group of user equipments). In such situations, it might be challenging not only to provide for the mentioned coordination when applying discontinuous transmission-reception pattern involving a plurality of user equipments but also to provide for corresponding signaling procedures.

Further, different communications service might have different requirements in terms of communication needs, typically resulting in periodic communication opportunities between the network and the user equipments. Hence there is no “one fits all” communication opportunity pattern which can be realized by a single discontinuous transmission-reception pattern.

### SUMMARY

In an exemplary embodiment, the present invention provides a method for operating a radio access network of a mobile communication network with at least one user equipment, the radio access network comprising at least one base station entity and the at least one user equipment being connected with, or served by, the at least one base station entity. In case that the user equipment is in connected mode, both the base station entity and the user equipment are configured to apply or to use a connected mode discontinuous transmission-reception pattern, wherein, according to the connected mode discontinuous transmission-reception pattern, repeatedly occurring active time intervals are defined such that data transmission and/or reception occurs, in uplink and/or in downlink direction and between the base station entity on the one hand and the user equipment on the other hand. In order to operate the base station entity with the user equipment, the method comprises the following steps: in a first step, the user equipment transmits a scheduling request indication to the base station entity, and in a second step, the base station entity transmits a control signaling to the user equipment, the transmission of the control signaling resulting in the base station entity and the user equipment being configured to apply or to use a further connected mode discontinuous transmission-reception pattern, wherein, according to the further connected mode discontinuous transmission-reception pattern, besides the repeatedly occurring active time intervals, repeatedly occurring additional active time intervals are defined and used for data transmission and/or reception, in uplink and/or in downlink direction, between the base station entity on the one hand and the user equipment on the other hand.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a telecommunications network comprising an access network, a core network and a user equipment as well as a further user equipment, wherein the (radio) access network comprises a number of base station entities providing radio coverage for specific geographical areas, respectively.

FIG. 2 schematically illustrates different connected mode discontinuous transmission-reception pattern according to the present invention.

### DETAILED DESCRIPTION

Exemplary embodiments of the present invention provide an effective and simple approach for operating a radio access network of a mobile communication network with at least one user equipment, wherein both the base station entity and the user equipment are configured to apply or to use the most appropriate discontinuous transmission-reception pattern in a flexible manner and with reduced signaling requirements. Further exemplary embodiments of the present invention provide a corresponding user equipment, a corresponding base station entity, a corresponding system or a telecommunications network, and a corresponding program and computer-readable medium.

In an exemplary embodiment, the present invention provides a method for operating a radio access network of a mobile communication network with at least one user equipment, the radio access network comprising at least one base station entity and the at least one user equipment being connected with, or served by, the at least one base station entity, wherein, in case that the user equipment is in connected mode, both the base station entity and the user equipment are configured to apply or to use a connected mode discontinuous transmission-reception pattern,
wherein, according to the connected mode discontinuous transmission-reception pattern, repeatedly occurring active time intervals are defined such that data transmission and/or reception occurs, in uplink and/or in downlink direction and between the base station entity on the one hand and the user equipment on the other hand,
wherein, in order to operate the base station entity with the user equipment, the method comprises the following steps:
   in a first step, the user equipment transmits a scheduling request indication to the base station entity,
   in a second step, the base station entity transmits a control signaling to the user equipment, the transmission of the control signaling resulting in the base station entity and the user equipment being configured to apply or to use a further connected mode discontinuous transmission-reception pattern, wherein, according to the further connected mode discontinuous transmission-reception pattern, besides the repeatedly occurring active time intervals, repeatedly occurring additional active time intervals are defined and used for data transmission and/or reception, in uplink and/or in downlink direction, between the base station entity on the one hand and the user equipment on the other hand.

It is thereby advantageously possible, according to the present invention, that it is easily possible to provide for the use of a better or more optimally adapted discontinuous transmission-reception pattern between the base station entity on the one hand and the user equipments (within the radio coverage area of the considered base station entity) on the other hand; especially it is advantageously possible to apply different kinds of discontinuous transmission-reception pattern regarding different user equipments or groups of user equipments in a comparatively easy manner and without requiring huge signaling efforts.

This is especially relevant if voice-related communication services (or voice-centric communication services) are involved: Typically, voice-related or voice-centric communication or communication services require active time intervals (i.e. time intervals during which the respective base station entity is able to transmit and receive data, especially user plane data) at least every 20 ms to 60 ms; in contrast, other communication services are able to be provided while applying a more relaxed discontinuous transmission-reception pattern between the base station entity and the user equipments concerned (with off-times possibly exceeding 80 ms, 100 ms or even 150 ms).

Hence, in case that, in a radio cell or in a radio coverage area served by a base station entity, there are 100 user equipments (especially in connected mode) that only require (for their communication needs or the requested communication services) a relaxed discontinuous transmission-reception pattern, and one specific user equipment of these user equipments needs to be provided with voice-related or voice-centric communication services (typically a voice call, either mobile originated or mobile terminated), there is potentially the need to change (or to adapt) the discontinuous transmission-reception pattern (applied prior to the voice-related or voice-centric communication need) not only for the specific user equipment but also for the other 99 user equipments as well. Likewise, this might involve signaling procedures to be conducted not only for the specific user equipment but also for the other 99 user equipment as well. The same might also be required (in opposite direction) after termination of the voice-related or voice-centric communication need. This is especially the case that for base station implementation simplicity reasons only one discontinuous transmission-reception pattern should be active at a given time instance, especially if this single discontinuous transmission-reception pattern is applied on a single frequency of the radio access network of a mobile communication network.

According to the present invention, such a scenario is advantageously able to be avoided, and, hence, not only the change of the applied discontinuous transmission-reception pattern (regarding the other 99 user equipments) avoided but also the associated signaling procedures (regarding the other 99 user equipments) avoided. Additionally, it is avoided to operate a base station entity of a radio access network of a mobile communication network with more than a single discontinuous transmission-reception pattern.

However, it might be beneficial to allow the other 99 (or at least part thereof) user equipments to use the increased communication possibilities provided by the further connected mode discontinuous transmission-reception pattern; this might, e.g., be indicated, by the base station entity, via a signaling procedure (e.g. via broadcast or dedicated signaling); in such a situation, of course, upon termination of the further connected mode discontinuous transmission-reception pattern, this termination also needs to be signaled accordingly.

According to the present invention, this is able to be achieved by means of, in case that a considered user equipment is in connected mode, both the base station entity and the user equipment being configured to apply or to use a connected mode discontinuous transmission-reception pattern that has repeatedly occurring active time intervals. In case that the considered user equipment needs (due to its communication needs, especially in case of voice-centric communication services being requested) a less relaxed (connected mode) discontinuous transmission-reception pattern, the further connected mode discontinuous transmission-reception pattern is used which provides, besides the repeatedly occurring active time intervals, repeatedly occurring additional active time intervals.

Hence, according to the present invention the (repeatedly occurring) active time intervals (of or provided by the connected mode discontinuous transmission-reception pattern) are identically reused when applying the further connected mode discontinuous transmission-reception pattern, but in addition to those active time intervals, the additional active time intervals are able to be used for data transmission and/or reception, in uplink and/or in downlink direction, between the base station entity on the one hand and the user equipment on the other hand.

Especially, by means of providing the connected mode discontinuous transmission-reception pattern and the further connected mode discontinuous transmission-reception pattern according to the present invention, it is furthermore advantageously possible to save energy not only on the side of the base station entity, but—perhaps even more importantly as the user equipments are typically realized as battery powered devices—also on the side of the user equipments: In the scenario described, it is, hence, advantageously possible to avoid any modification of the applied connected mode discontinuous transmission-reception pattern (and also any additional active time periods) regarding the 99 user equipments that are not involved in higher-demand (e.g. less-latency) communication services (such as voice-centric communication services); additionally, any associated signaling effort is able to be avoided, likewise reducing energy consumption needs—both on the side of those user equipments and on the side of the base station entity.

According to the present invention, it is advantageously possible and preferred that data transmission and/or reception, especially user plane data transmission and/or reception, in uplink and/or in downlink direction and between the base station entity and the user equipment, occurs
when applying the connected mode discontinuous transmission-reception pattern only during the active time intervals and
when applying the further connected mode discontinuous transmission-reception pattern only during either the active time intervals or the additional active time intervals, wherein especially the further connected mode discontinuous transmission-reception pattern is defined by means of both the active time intervals and the additional active time intervals, wherein especially the active time intervals, while the connected mode discontinuous transmission-reception pattern is applied, correspond to a proper subset of the active time intervals while the further connected mode discontinuous transmission-reception pattern is applied.

By means of being able to deactivate, at least partly, the base station entity during the off-time periods (i.e. outside of the active time intervals and/or outside the additional active time intervals), it is advantageously possible to save significant energy at the base station entity as well as on the side of the involved user equipments.

According to the present invention, it is furthermore advantageously possible and preferred that the further connected mode discontinuous transmission-reception pattern is used in order to provide the user equipment with one or a plurality of voice-centric communication services,
wherein especially, in a third step subsequent to the second step and after termination of the one or plurality of voice-centric communication services, the user equipment terminates using the further connected mode discontinuous transmission-reception pattern and again uses or applies the connected mode discontinuous transmission-reception pattern,
wherein especially this transition to using or applying the connected mode discontinuous transmission-reception pattern involves a further control signaling transmitted, by the base station entity, to the user equipment, or this transition is applied implicitly, without further control signaling, by the user equipment after termination of the voice-centric communication service.

According to the present invention, it is thereby advantageously possible that exemplary embodiments of the inventive method are able to be performed in a flexible and efficient manner.

According to the present invention, it is furthermore advantageously possible and preferred that the control signaling, transmitted to the user equipment, comprises the definition of the further connected mode discontinuous transmission-reception pattern, wherein especially, by means of the control signaling, the previously applied configuration regarding the application of the connected mode discontinuous transmission-reception pattern is overwritten or deleted.

According to the present invention, it is thereby advantageously possible that exemplary embodiments of the inventive method are able to be performed in a flexible and efficient manner.

According to the present invention, it is furthermore advantageously possible and preferred that the user equipment—while being connected with, or served by, the base station entity—is configured such as to comprise configuration information regarding both the connected mode discontinuous transmission-reception pattern and the further connected mode discontinuous transmission-reception pattern, wherein the user equipment is able to alternatively be operated either in a first mode of operation or in a second mode of operation, wherein, in the first mode of operation, the user equipment applies or uses the connected mode discontinuous transmission-reception pattern and wherein, in the second mode of operation, the user equipment applies or uses the further connected mode discontinuous transmission-reception pattern, wherein the control signaling, transmitted to the user equipment comprises the information to apply or use the second mode of operation rather than the first mode of operation.

According to the present invention, it is thereby advantageously possible that exemplary embodiments of the inventive method are able to be performed in a flexible and efficient manner. Especially, by means of the user equipment comprising configuration information regarding both the connected mode discontinuous transmission-reception pattern and the further connected mode discontinuous transmission-reception pattern, it is advantageously possible to even further reduce the signaling efforts in order to change the applied connected mode discontinuous transmission-reception pattern, as the respective connected mode discontinuous transmission-reception pattern only needs to be indicated (and not necessarily its definition to be transmitted).

According to the present invention, it is furthermore advantageously possible and preferred that—besides the user equipment—at least a further user equipment is connected with, or served by, the base station entity,
wherein, in case that both user equipments are in connected mode, both user equipments are configured to apply or to use the connected mode discontinuous transmission-reception pattern,
wherein, after the base station entity having transmitted the control signaling to the user equipment in response to the scheduling request indication, the further user equipment still applies the connected mode discontinuous transmission-reception pattern, wherein especially no control signaling is required to be transmitted to the further user equipment.

According to the present invention, it is thereby advantageously possible that exemplary embodiments of the inventive method are able to be performed in a flexible and efficient manner.

According to the present invention, it is furthermore advantageously possible and preferred that both the base station entity and the user equipment are configured to apply or to use a second further connected mode discontinuous transmission-reception pattern, wherein according to the second further connected mode discontinuous transmission-reception pattern repeatedly occurring further additional active time intervals are defined—in addition to the active time intervals—such that data transmission and/or reception occurs, in uplink and/or in downlink direction and between the base station entity on the one hand and the user equipment on the other hand, during either the active time intervals or the further additional active time intervals,
wherein especially the further additional active time intervals is a proper subset of the additional active time intervals.

According to the present invention, it is thereby advantageously possible that exemplary embodiments of the inventive method are able to be performed in a flexible and efficient manner.

According to the present invention, it is furthermore advantageously possible and preferred that the connected mode discontinuous transmission-reception pattern is defined by means of indicating at least one of the following:
a point in time indicating the beginning of one of the active time intervals and a repetition time interval,
the points in time indicating the beginning of the active time intervals, respectively, and/or
   wherein the further connected mode discontinuous transmission-reception pattern is defined by means of indicating at least one of the following:
a point in time indicating the beginning of one of the active time intervals or one of the additional active time intervals and a further repetition time interval,
the points in time indicating the beginning of the active time intervals, respectively, and of the additional active time intervals, respectively,
   wherein especially the point or points in time indicating the beginning of one or a plurality of the active time intervals or of the additional active time intervals is/are defined using an offset time interval, wherein the offset time interval is defined with regard to a point in time or with regard to a plurality of points in time corresponding to the system frame number being equal to zero or an offset to zero.

According to the present invention, it is thereby advantageously possible that exemplary embodiments of the inventive method are able to be performed in a flexible and efficient manner.

Furthermore, the present invention relates to a user equipment for being operated with a radio access network of a mobile communication network, wherein the user equipment is configured to connect to or be served by at least one base station entity as part of the radio access network,
wherein, in case that the user equipment is in connected mode, the user equipment is configured to apply or to use a connected mode discontinuous transmission-reception pattern,
wherein the user equipment is configured such that, according to the connected mode discontinuous transmission-reception pattern, repeatedly occurring active time intervals are defined such that data transmission and/or reception occurs, in uplink and/or in downlink direction and between the base station entity on the one hand and the user equipment on the other hand,
wherein, in order to being operated with the base station entity, the user equipment is configured such that:
   the user equipment transmits a scheduling request indication to the base station entity,
   the user equipment receives, from the base station entity, a control signaling, the reception of the control signaling resulting in the user equipment being configured to apply or to use a further connected mode discontinuous transmission-reception pattern, wherein, according to the further connected mode discontinuous transmission-reception pattern, besides the repeatedly occurring active time intervals, repeatedly occurring additional active time intervals are defined and used for data transmission and/or reception, in uplink and/or in downlink direction, between the base station entity on the one hand and the user equipment on the other hand.

Additionally, the present invention relates to a base station entity for being operated as part of a radio access network of a mobile communication network and with at least one user equipment, the user equipment being connected with, or served by, the base station entity,
wherein, in case that the user equipment is in connected mode, both the base station entity and the user equipment are configured to apply or to use a connected mode discontinuous transmission-reception pattern,
wherein the base station entity is configured such that, according to the connected mode discontinuous transmission-reception pattern, repeatedly occurring active time intervals are defined such that data transmission and/or reception occurs, in uplink and/or in downlink direction and between the base station entity on the one hand and the user equipment on the other hand,
wherein, in order to operate the base station entity with the user equipment, the base station entity is configured such that:
   the base station entity receives a scheduling request indication from the user equipment,
   the base station entity transmits a control signaling to the user equipment, the transmission of the control signaling resulting in the base station entity and the user equipment being configured to apply or to use a further connected mode discontinuous transmission-reception pattern, wherein, according to the further connected mode discontinuous transmission-reception pattern, besides the repeatedly occurring active time intervals, repeatedly occurring additional active time intervals are defined and used for data transmission and/or reception, in uplink and/or in downlink direction, between the base station entity on the one hand and the user equipment on the other hand.

Additionally, the present invention relates to a system or to a mobile communication network for operating a radio access network of the mobile communication network with at least one user equipment, the radio access network comprising at least one base station entity and the at least one user equipment being connected with, or served by, the at least one base station entity,
wherein, in case that the user equipment is in connected mode, both the base station entity and the user equipment are configured to apply or to use a connected mode discontinuous transmission-reception pattern,
wherein, according to the connected mode discontinuous transmission-reception pattern, repeatedly occurring active time intervals are defined such that data transmission and/or reception occurs, in uplink and/or in downlink direction and between the base station entity on the one hand and the user equipment on the other hand,
wherein, in order to operate the base station entity with the user equipment, the system or mobile communication network is configured such that:
   the user equipment transmits a scheduling request indication to the base station entity,
   the base station entity transmits a control signaling to the user equipment, the transmission of the control signaling resulting in the base station entity and the user equipment being configured to apply or to use a further connected mode discontinuous transmission-reception pattern, wherein, according to the further connected mode discontinuous transmission-reception pattern, besides the repeatedly occurring active time intervals, repeatedly occurring additional active time intervals are defined and used for data transmission and/or reception, in uplink and/or in downlink direction, between the base station entity on the one hand and the user equipment on the other hand.

Additionally, the present invention relates to a program comprising a computer readable program code which, when executed on a computer or on a user equipment or on a base station entity, or in part on the user equipment and/or in part on the base station entity, causes the computer or the user equipment or the base station entity, to perform exemplary embodiments of the inventive method.

Still additionally, the present invention relates to a computer-readable medium comprising instructions which, when executed on a computer or on a user equipment or on a base station entity, or in part on the user equipment and/or in part on the base station entity, causes the computer or the user equipment or the base station entity, to perform exemplary embodiments of the inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

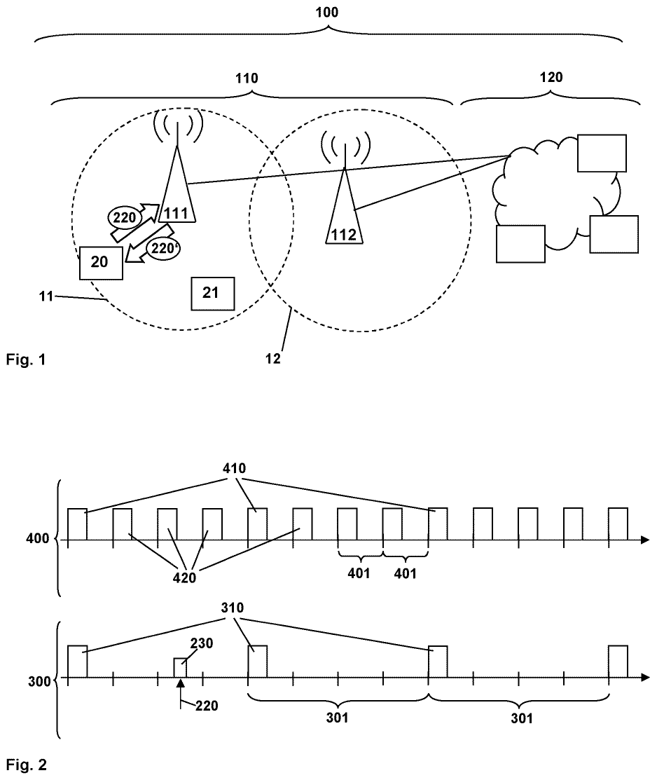

In FIG. 1, a telecommunications network 100 comprising an access network 110, and a core network 120 is schematically shown. The telecommunications network 100 or also mobile communication network 100 is typically realized as a cellular network or cellular mobile communication network 100. The mobile communication network 100, especially the core network 120, typically comprises a number of network functions or services that are not specifically indicated by means of a reference sign. Examples of such network functions or services include, e.g., an access and mobility management function, AMF, and/or a user plane function, UPF—especially in case of a 5G mobile communication network. The access network 110 or radio access network 110 comprises a plurality of radio cells 11, 12, i.e. geographical areas served, respectively, by base station entities. In the exemplary situation or scenario shown in FIG. 1, a first base station entity 111 generates or is associated with or spans the first radio cell 11, and a second base station entity 112 generates or is associated with or spans the second radio cell 12. The base station entities 111, 112 typically realize gNB functionality or next-generation gNB functionality. The mobile communication network 100 is typically connected to a plurality of user equipments (or, rather, the user equipments are connected to the telecommunications network 100). FIG. 1 schematically shows a user equipment 20 and a further user equipment 21.

As shown in FIG. 1, according to the present invention, the user equipment 20 is connected with, or served by, the base station entity 111.

In case that the user equipment 20 is in connected mode, both the base station entity 111 and the user equipment 20 are configured to apply or to use a connected mode discontinuous transmission-reception pattern.

The connected mode discontinuous transmission-reception pattern 300 is schematically shown in FIG. 1—together with the further connected mode discontinuous transmission-reception pattern 400:

According to the connected mode discontinuous transmission-reception pattern 300, repeatedly occurring (i.e. having a repetition time interval 301) active time intervals 310 are defined such that data transmission and/or reception is able to occur, in uplink and/or in downlink direction and between the base station entity 111 on the one hand and the user equipment 20 on the other hand.
FIG. 2 schematically and exemplarily shows—by means of a horizontal arrow regarding the connected mode discontinuous transmission-reception pattern 300—a time evolution. During the time evolution represented, four occasions of active time intervals 310 are schematically shown (but only three of which are indicated by means of reference sign 310).
Furthermore, FIG. 2 represents the further connected mode discontinuous transmission-reception pattern 400; according to the further connected mode discontinuous transmission-reception pattern 400, repeatedly occurring active time intervals 410 and (likewise repeatedly occurring) additional active time intervals 420—both kinds of active time intervals 410, 420 having, collectively, a further repetition time interval 401—are defined such that data transmission and/or reception is able to occur, in uplink and/or in downlink direction and between the base station entity 111 on the one hand and the user equipment 20 on the other hand.

As well regarding the further connected mode discontinuous transmission-reception pattern 400, FIG. 2 schematically and exemplarily shows—likewise by means of a horizontal arrow—a time evolution. During the time evolution represented, likewise four occasions of active time intervals 410 are schematically shown (but only three of which are indicated by means of reference sign 410); furthermore, the time evolution shows the additional active time intervals 420—represented between the active time intervals 410, wherein, exemplarily, in-between two succeeding active time intervals 410 three additional time intervals 420 are located, respectively (but only fourth of which are indicated by means of reference sign 420). The connected mode discontinuous transmission-reception pattern 300 is defined by means of the respective active time intervals, especially by means of indicating at least one of the following:
a point in time indicating the beginning of one of the active time intervals 310 and the repetition time interval 301,
the points in time indicating the beginning of the active time intervals 310, respectively. The further connected mode discontinuous transmission-reception pattern 400 is likewise defined by means of its respective active time intervals, especially by means of indicating at least one of the following:
a point in time indicating the beginning of one of the active time intervals 310 or one of the additional active time intervals 420 and the further repetition time interval 401,
the points in time indicating the beginning of the active time intervals 310, respectively, and of the additional active time intervals 420, respectively.
   Especially the point or points in time indicating the beginning of one or a plurality of the active time intervals 310, 410 or of the additional active time intervals 420 is/are defined using an offset time interval, wherein the offset time interval is defined with regard to a point in time or with regard to a plurality of points in time corresponding to the system frame number being equal to zero or an offset to zero.

According to the present invention, in case that the user equipment 20 requires the connected mode discontinuous transmission-reception pattern to be changed (especially towards a less relaxed discontinuous transmission-reception pattern, i.e. having a reduced repetition time interval such as the further repetition time interval 401 compared to the repetition time interval 301), the user equipment 20 transmits a scheduling request indication 220 to the base station entity 111. This is schematically shown in FIG. 1 by means of an arrow directing from the user equipment 20 towards the base station entity 111.

As a result, the base station entity 111 transmits a control signaling 220′ to the user equipment 20 (schematically represented, in FIG. 1, by means of an arrow directing from the base station entity 111 towards the user equipment 20).
The transmission of the control signaling 220′ results in the base station entity 111 and the user equipment 20 being configured to apply or to use the further connected mode discontinuous transmission-reception pattern 400, wherein, according to the further connected mode discontinuous transmission-reception pattern 400, besides the repeatedly occurring active time intervals 310 (or 410), the repeatedly occurring additional active time intervals 420 are defined and are used (or able to be used) for data transmission and/or reception, in uplink and/or in downlink direction, between the base station entity 111 on the one hand and the user equipment 20 on the other hand.

An event of the user equipment 20 requiring the (hitherto applied) connected mode discontinuous transmission-reception pattern to be changed (towards a less relaxed discontinuous transmission-reception pattern, having a reduced further repetition time interval 401) is exemplarily shown in FIG. 2: the user equipment 20 transmits, to the base station entity 111, the scheduling request indication 220 which results in the connected mode discontinuous transmission-reception pattern to be changed; especially the scheduling request indication 220 is required to be sent, by the user equipment 20, during a random access occasion (such as a random access channel (RACH) occasion) time period; such a random access occasion is schematically designated, in FIG. 2, by means of reference sign 230.

In the example shown, the repetition time interval 301 corresponds to four times the further repetition time interval 401 (i.e. 4:1)—of course, other ratios are possible and preferred according to the present invention, especially 2:1; 8:1; 16:1; 32:1.

Especially the further repetition time interval 401 might correspond, e.g., to 10 ms, or to 20 ms, or to 30 ms, or to 40 ms, whereas the repetition time interval 301 might correspond to 80 ms, or to 120 ms, or to 160 ms, or to 240 ms, or to 320 ms, or to 640 ms, or to 1280 ms, or to 2560 ms.

Furthermore, it is advantageously possible to implement—besides the connected mode discontinuous transmission-reception pattern 300 and the further connected mode discontinuous transmission-reception pattern 400—a second further connected mode discontinuous transmission-reception pattern. Especially, according to the second further connected mode discontinuous transmission-reception pattern repeatedly occurring further additional active time intervals are defined—in addition to the active time intervals 310 (of the connected mode discontinuous transmission-reception pattern 300)—such that data transmission and/or reception occurs, in uplink and/or in downlink direction and between the base station entity 111 on the one hand and the user equipment 20 on the other hand, during either the active time intervals 310 or the further additional active time intervals. Especially the further additional active time intervals is a proper subset of the additional active time intervals 420 (i.e. per unit of time there are less further additional active time intervals compared to additional active time intervals, i.e. the second further repetition time interval of the second further connected mode discontinuous transmission-reception pattern is larger (longer) than the further repetition time interval 401 but shorter than the repetition time interval 301. Especially, the second further connected mode discontinuous transmission-reception pattern might be applied in case that there is no requirement of providing voice-centric communication services (i.e. applying the further connected mode discontinuous transmission-reception pattern 400) but the communication requirements are such that applying the connected mode discontinuous transmission-reception pattern 300 would be insufficient.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a radio access network of a mobile communication network with at least one user equipment, the radio access network comprising at least one base station entity and the at least one user equipment being connected with, or served by, the at least one base station entity,
wherein, in case that the user equipment is in connected mode, both the base station entity and the user equipment are configured to apply or to use a connected mode discontinuous transmission-reception pattern
wherein, according to the connected mode discontinuous transmission-reception pattern repeatedly occurring active time intervals are defined such that data transmission and/or reception occurs, in uplink and/or in downlink direction and between the base station entity on the one hand and the user equipment on the other hand,
wherein, in order to operate the base station entity with the user equipment the method comprises the following steps:
in a first step, the user equipment transmits a scheduling request indication to the base station entity, and
in a second step, the base station entity transmits a control signaling to the user equipment, the transmission of the control signaling resulting in the base station entity and the user equipment being configured to apply or to use a further connected mode discontinuous transmission-reception pattern, wherein, according to the further connected mode discontinuous transmission-reception pattern, besides the repeatedly occurring active time intervals repeatedly occurring additional active time intervals are defined and used for data transmission and/or reception, in uplink and/or in downlink direction, between the base station entity on the one hand and the user equipment on the other hand.

2. The method according to claim 1, wherein data transmission and/or reception, especially user plane data transmission and/or reception, in uplink and/or in downlink direction and between the base station entity and the user equipment, occurs
when applying the connected mode discontinuous transmission-reception pattern only during the active time intervals and
when applying the further connected mode discontinuous transmission-reception pattern only during either the active time intervals or the additional active time intervals,
wherein especially the further connected mode discontinuous transmission-reception pattern is defined by means of both the active time intervals and the additional active time intervals,
wherein especially the active time intervals, while the connected mode discontinuous transmission-reception pattern is applied, correspond to a proper subset of the active time intervals while the further connected mode discontinuous transmission-reception pattern is applied.

3. The method according to claim 1, wherein the further connected mode discontinuous transmission-reception pattern is used in order to provide the user equipment with one or a plurality of voice-centric communication services,
wherein especially, in a third step subsequent to the second step and after termination of the one or plurality of voice-centric communication services, the user equipment terminates using the further connected mode discontinuous transmission-reception pattern and again uses or applies the connected mode discontinuous transmission-reception pattern,
wherein especially this transition to using or applying the connected mode discontinuous transmission-reception pattern involves a further control signaling transmitted, by the base station entity, to the user equipment or this transition is applied implicitly, without further control signaling, by the user equipment after termination of the voice-centric communication service.

4. The method according to claim 1, wherein the control signaling transmitted to the user equipment comprises the definition of the further connected mode discontinuous transmission-reception pattern,
wherein especially, by means of the control signaling, the previously applied configuration regarding the application of the connected mode discontinuous transmission-reception pattern is overwritten or deleted.

5. The method according to claim 1, wherein the user equipment—while being connected with, or served by, the base station entity—is configured such as to comprise configuration information regarding both the connected mode discontinuous transmission-reception pattern and the further connected mode discontinuous transmission-reception pattern wherein the user equipment is able to alternatively be operated either in a first mode of operation or in a second mode of operation,
wherein, in the first mode of operation, the user equipment applies or uses the connected mode discontinuous transmission-reception pattern and wherein, in the second mode of operation, the user equipment applies or uses the further connected mode discontinuous transmission-reception pattern, wherein the control signaling transmitted to the user equipment comprises the information to apply or use the second mode of operation rather than the first mode of operation.

6. The method according to claim 1, wherein—besides the user equipment—at least a further user equipment is connected with, or served by, the base station entity,
wherein, in case that both user equipments are in connected mode, both user equipments are configured to apply or to use the connected mode discontinuous transmission-reception pattern
wherein, after the base station entity having transmitted the control signaling to the user equipment in response to the scheduling request indication the further user equipment still applies the connected mode discontinuous transmission-reception pattern, wherein especially no control signaling is required to be transmitted to the further user equipment.

7. The method according to claim 1, wherein both the base station entity and the user equipment are configured to apply or to use a second further connected mode discontinuous transmission-reception pattern, wherein according to the second further connected mode discontinuous transmission-reception pattern repeatedly occurring further additional active time intervals are defined—in addition to the active time intervals—such that data transmission and/or reception occurs, in uplink and/or in downlink direction and between the base station entity on the one hand and the user equipment on the other hand, during either the active time intervals or the further additional active time intervals,
wherein especially the further additional active time intervals is a proper subset of the additional active time intervals.

8. The method according to claim 1, wherein:
the connected mode discontinuous transmission-reception pattern is defined by means of indicating at least one of the following:
a point in time indicating the beginning of one of the active time intervals and a repetition time interval (301), or
the points in time indicating the beginning of the active time intervals respectively, and/or
the further connected mode discontinuous transmission-reception pattern is defined by means of indicating at least one of the following:
a point in time indicating the beginning of one of the active time intervals or one of the additional active time intervals and a further repetition time interval, or
the points in time indicating the beginning of the active time intervals respectively, and of the additional active time intervals respectively,
wherein especially the point or points in time indicating the beginning of one or a plurality of the active time intervals or of the additional active time intervals is/are defined using an offset time interval, wherein the offset time interval is defined with regard to a point in time or with regard to a plurality of points in time corresponding to the system frame number being equal to zero or an offset to zero.

9. A user equipment for being operated with a radio access network of a mobile communication network, wherein the user equipment is configured to connect to or be served by at least one base station entity as part of the radio access network,
wherein, in case that the user equipment is in connected mode, the user equipment is configured to apply or to use a connected mode discontinuous transmission-reception pattern,
wherein the user equipment is configured such that, according to the connected mode discontinuous transmission-reception pattern repeatedly occurring active time intervals are defined such that data transmission and/or reception occurs, in uplink and/or in downlink direction and between the base station entity on the one hand and the user equipment on the other hand,
wherein, in order to being operated with the base station entity, the user equipment is configured such that:
the user equipment transmits a scheduling request indication to the base station entity, and
the user equipment receives, from the base station entity, a control signaling, the reception of the control signaling resulting in the user equipment being configured to apply or to use a further connected mode discontinuous transmission-reception pattern, wherein, according to the further connected mode discontinuous transmission-reception pattern besides the repeatedly occurring active time intervals, repeatedly occurring additional active time intervals are defined and used for data transmission and/or reception, in uplink and/or in downlink direction, between the base station entity on the one hand and the user equipment on the other hand.

10. A base station entity for being operated as part of a radio access network of a mobile communication network and with at least one user equipment, the user equipment being connected with, or served by, the base station entity,
wherein, in case that the user equipment is in connected mode, both the base station entity and the user equipment are configured to apply or to use a connected mode discontinuous transmission-reception pattern,
wherein the base station entity is configured such that, according to the connected mode discontinuous transmission-reception pattern repeatedly occurring active time intervals are defined such that data transmission and/or reception occurs, in uplink and/or in downlink direction and between the base station entity on the one hand and the user equipment on the other hand,
wherein, in order to operate the base station entity with the user equipment the base station entity is configured such that:
the base station entity receives a scheduling request indication from the user equipment, and
the base station entity transmits a control signaling to the user equipment the transmission of the control signaling resulting in the base station entity and the user equipment being configured to apply or to use a further connected mode discontinuous transmission-reception pattern wherein, according to the further connected mode discontinuous transmission-reception pattern, besides the repeatedly occurring active time intervals repeatedly occurring additional active time intervals are defined and used for data transmission and/or reception, in uplink and/or in downlink direction, between the base station entity on the one hand and the user equipment on the other hand.

11. A system or mobile communication network for operating a radio access network of the mobile communication network with at least one user equipment, the radio access network comprising at least one base station entity and the at least one user equipment being connected with, or served by, the at least one base station entity,
wherein, in case that the user equipment is in connected mode, both the base station entity and the user equipment are configured to apply or to use a connected mode discontinuous transmission-reception pattern,
wherein, according to the connected mode discontinuous transmission-reception pattern, repeatedly occurring active time intervals are defined such that data transmission and/or reception occurs, in uplink and/or in downlink direction and between the base station entity on the one hand and the user equipment on the other hand,
wherein, in order to operate the base station entity with the user equipment, the system or mobile communication network is configured such that:
the user equipment transmits a scheduling request indication to the base station entity, and
the base station entity transmits a control signaling to the user equipment the transmission of the control signaling resulting in the base station entity and the user equipment being configured to apply or to use a further connected mode discontinuous transmission-reception pattern wherein, according to the further connected mode discontinuous transmission-reception pattern, besides the repeatedly occurring active time intervals repeatedly occurring additional active time intervals are defined and used for data transmission and/or reception, in uplink and/or in downlink direction, between the base station entity on the one hand and the user equipment on the other hand.

12. A program comprising a computer readable program code which, when executed on a computer or on a user equipment or on a base station entity, or in part on the user equipment and/or in part on the base station entity, causes the computer or the user equipment or the base station entity, to perform a the method according to claim 1.

13. A computer-readable medium comprising instructions which, when executed on a computer or on a user equipment or on a base station entity, or in part on the user equipment and/or in part on the base station entity, causes the computer or the user equipment or the base station entity to perform a the method according to claim 1.
